(19) United States
(12) Patent Application Publication
(10) Pub. No.: US 2005/0198395 A1
(43) Pub. Date: Sep. 8, 2005

(54) Reusable compressed objects

(76) Inventors: Pradeep Verma, San Jose, CA (US); Keith Garrett, (US)

Correspondence Address: GLENN PATENT GROUP, 3475 EDISON WAY, SUITE L, MENLO PARK, CA, 94025, US

(21) Appl. No.: 10/934,667

(22) Filed: Sep. 2, 2004

Related U.S. Application Data
(60) Provisional application No. 60/533,204, filed on Dec. 29, 2003.

(51) Int. Cl. G06F 15/16

(52) U.S. Cl. 709/247; 709/217

(57) ABSTRACT

The invention provides a method and apparatus for storing and accessing compressed objects for reuse. Compressed data, for example objects that are received from the Web, are written back to a cache. This allows the storage of multiple object sizes for the same object, depending on the compression settings. Once the object has been compressed, it is not necessary to compress it again. The invention also provides for compressing the object's header to achieve additional compression, for example, for a second request for the object if the request is received through a client. In clientless mode, it is not necessary to compress the header at all.

### CROSS REFERENCE TO RELATED APPLICATIONS

This Application claims priority and incorporates by reference the provisional application “Compressed Objects” Application No. 60/533,204 filed Dec. 29, 2003.

### BACKGROUND OF THE INVENTION

1. Technical Field

The invention related to a technique for saving compressed objects. More particularly, the invention relates to a technique for saving compressed objects for later retrieval.

2. Description of the Prior Art

Objects which represent information in electronic form, for example the HTML information that comprises Web pages or portions thereof, are often cached. This allows the object to be retrieved quickly, without the need to reload the object from the Web. Such objects often constitute a significant portion of the content provided to wireless devices, such as browser equipped cell phones. However, due to the differences in bandwidth between the Web and the wireless communications channel that allows the wireless device to communicate with a Web gateway, the object must first be compressed before it is sent to the wireless device via the wireless communications channel. The current practice is to store the whole object in the cache. When the object is requested again, it is necessary to get the full object from the cache and then compress it again, thereby using significant system resources. See FIG. 1, which is a block schematic diagram showing a request flow for an object without the use of a prefetch operation, in which the sequence of the flow is indicated by alpha-numeric designators A1->A6 associated with their corresponding arrows; and FIG. 2, which is a block schematic diagram showing a request flow for an object. In each of FIGS. 1 and 2, a client 11 requests an object from an object stored in a server 17 from a gateway 15 via a transport mechanism, such as HTTP. Upon retrieval, the object is compressed by a compressor 13 and then returned via the gateway to the requesting client. FIG. 2 shows the case where a prefetch operation is enabled. Thus, the object has been previously cached and can be retrieved locally for compression.

A further problem occurs when an object is requested at various levels of resolution. Currently, the object must be retrieved from the cache (or from the Web if the object is not cached) each time it is requested, and further it must be compressed using an appropriate degree of compression for the target device. This means that a particular object must be repeatedly compressed, where the object's resolution may be different each time it is compressed.

Finally, the object may be requested for various target devices, where different formats are required for the object. For example, the object may be required in HTML on one platform, but another platform may support ASCII instead. Thus, the object may have to be translated from its native format to a target platform format and then compressed each time it is requested.

These repeated compression and format translation operations add significant buffering and processing requirements to a system.

It would be advantageous to provide a method and apparatus for storing and accessing compressed objects for reuse. It would also be advantageous if such method and apparatus allowed for caching an object in one or more of several formats and/or degrees of resolution.

### SUMMARY OF THE INVENTION

The invention provides a method and apparatus for storing and accessing compressed objects for reuse. Compressed data, for example objects that are received from the Web, are written back to a cache. This allows the storage of multiple object sizes for the same object, depending on the compression settings. Once the object has been compressed, it is not necessary to compress it again. The invention also provides for compressing the object's header to achieve additional compression, for example, for a second request for the object if the request is received through a client. In clientless mode, it is not necessary to compress the header at all.

### BRIEF DESCRIPTION OF THE DRAWINGS

FIG. 1 is a block schematic diagram showing a request flow for an object without the use of a compressed object and a prefetch operation;

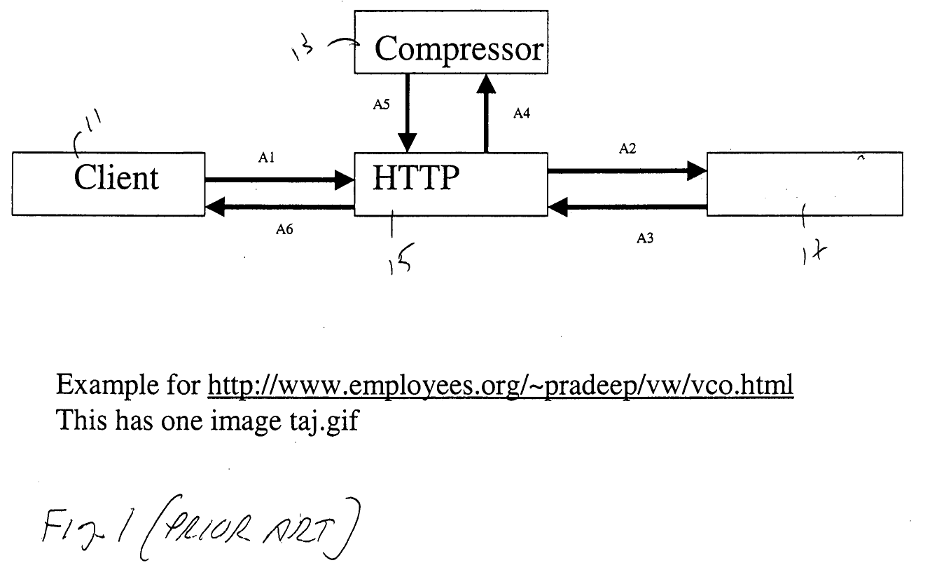

FIG. 2 is a block schematic diagram showing a request flow for an object without the use of a compressed object;

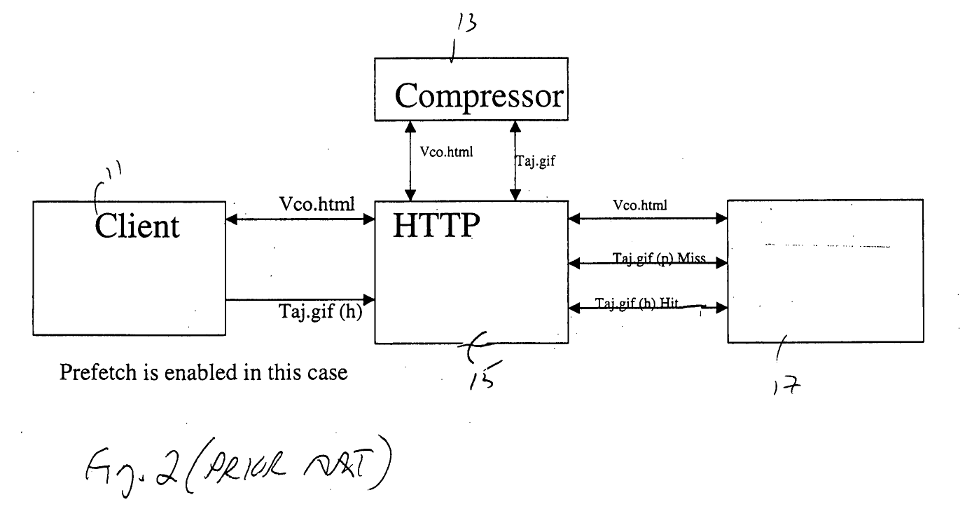

FIG. 3 is a block schematic diagram showing a request flow for an object according to a first embodiment of the invention;

FIG. 4 is a block schematic diagram showing a request flow for an object according to a second embodiment of the invention;

FIG. 5 is a block schematic diagram showing a request flow for an object according to a third embodiment of the invention;

FIG. 6 is a flow diagram that describes the flow of the request;

FIG. 7 is a flow diagram that describes the flow of the request on the prefetch side;

FIG. 8 is a flow diagram that describes the flow of the request when the CO is not present; and

FIG. 9 is a flow diagram that describes the flow of the request when the CO is not present.

### DETAILED DESCRIPTION OF THE INVENTION

The invention provides a method and apparatus for storing and accessing compressed objects for reuse. Compressed data, for example objects that are received from the Web, are written back to a cache. This allows the storage of multiple object sizes for the same object, depending on the compression settings. Once the object has been compressed, it is not necessary to compress it again. The invention also provides for compressing the object's header to achieve additional compression, for example, for a second request for the object if the request is received through a client. In clientless mode, it is not necessary to compress the header at all.

Definitions

The following mnemonics are used in this document for their associated meaning:

VS: This refers to the server.

VC: This refers to the client.

VCO: This is the data structure that is used to store the compressed object.

Prefetch: This is an underlying data structure which is enhanced by the invention.

COURL: This is a modified URL with a VCO extension

NMURL: This is a normal URL that is sent to the cache

CP: This is a cache proxy that is used for handling the COURL.

### Description

When an object is retrieved, it has to go through the compressor. The CPU is used quite heavily to compress the object. Doing the same compression on the same object is time consuming and slow. The invention arises from the observation that compressing the objects once and then saving them to the cache avoids much use of the CPU. The preferred embodiment of the invention saves the compressed object on the cache. When a new request for a particular object is received, it can be retrieved from the cache directly and sent to the client.

In the current embodiment, the original object is saved in the cache. Once the full object is received, the data are compressed, but the header is not compressed. The compressed object (VCO) is saved into the cache. Enough information is saved internally to identify the compression techniques used. One advantage of this approach is that the compressed object is saved in cache for subsequent use. When a request for that object is made again, the URL is translated into a corresponding COURL, which is maintained in an internal table. Thereafter, the compressed data can be retrieved directly from the cache. The data stored in the cache in this way use fewer buffers because they are compressed. This approach also uses less CPU and is faster because the data are transferred from the cache to the server in a much quicker time, i.e. there is less to transfer and no need to compress. When a VCO is requested, the header can be compressed relatively quickly because it is much smaller in size than the data which comprise the object itself. The VCO is then transferred to the client.

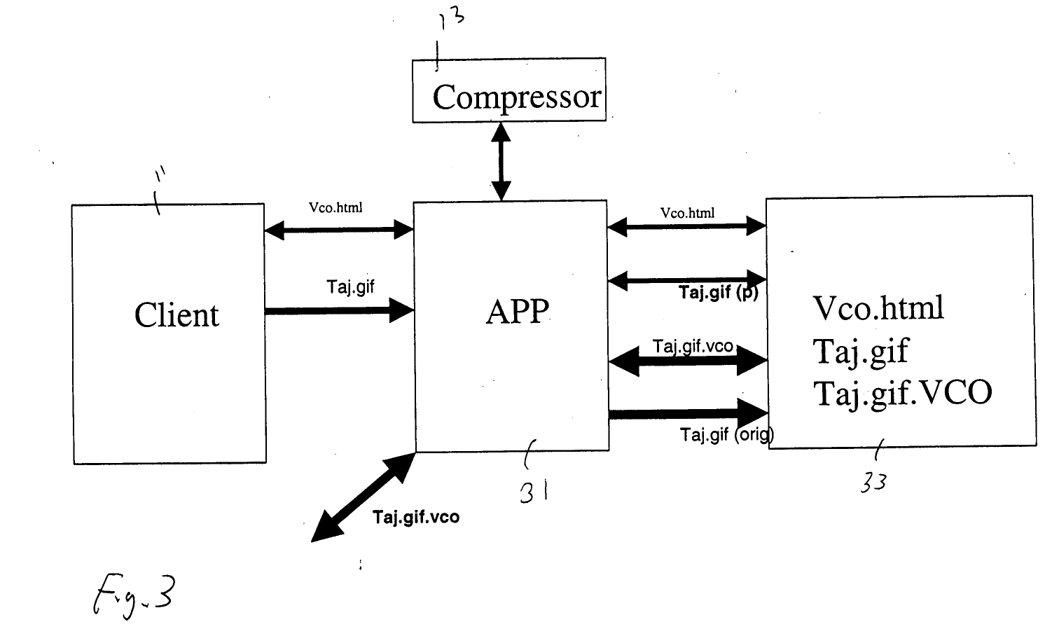

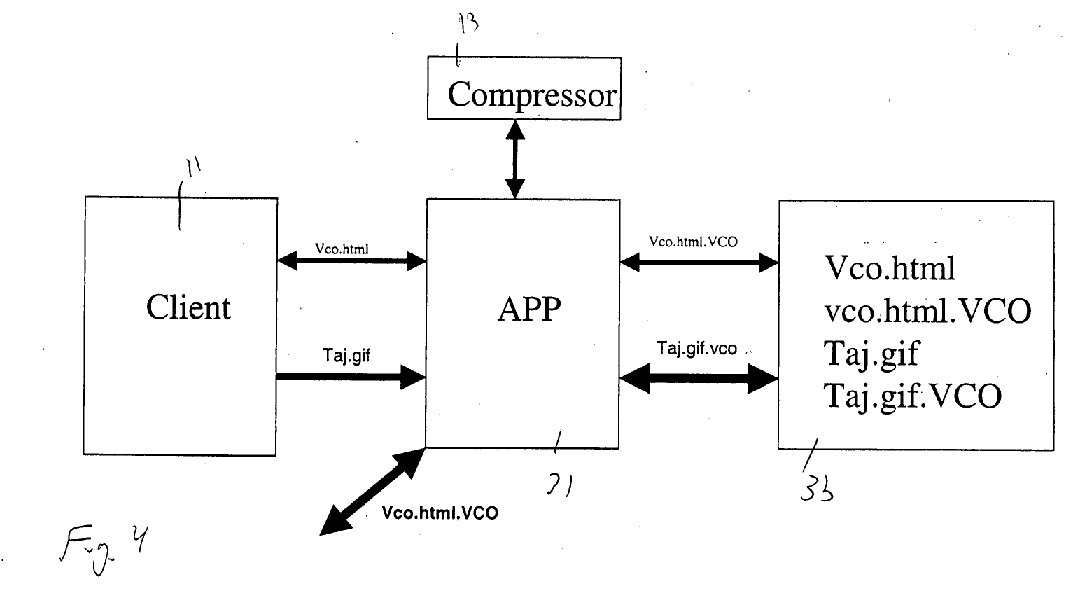

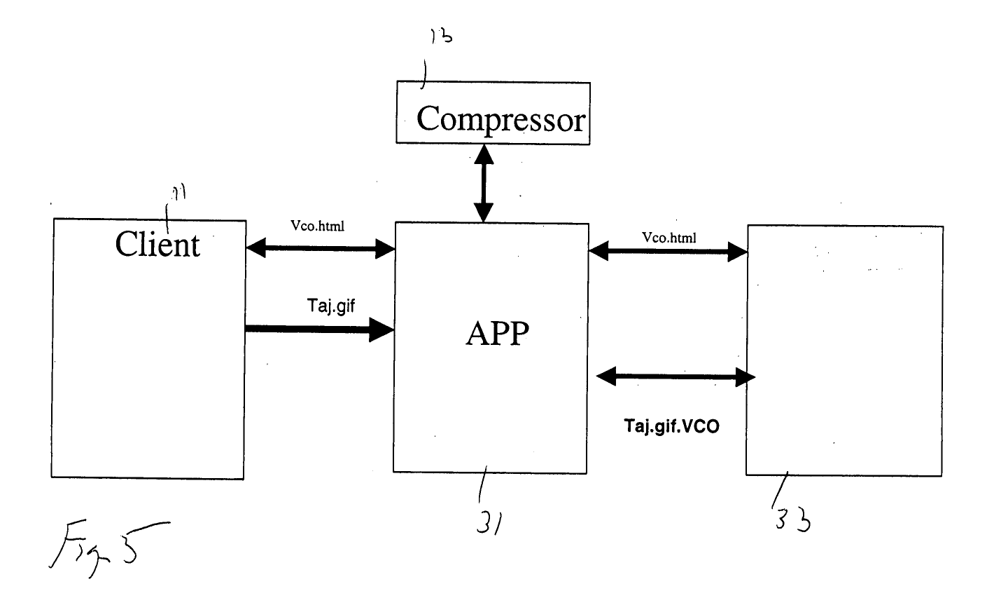

This is best seen in FIGS. 3-5, where FIG. 3 is a block schematic diagram showing a request flow for an object according to a first embodiment of the invention; FIG. 4 is a block schematic diagram showing a request flow for an object according to a second embodiment of the invention; and FIG. 5 is a block schematic diagram showing a request flow for an object according to a third embodiment of the invention.

Referring now to FIG. 3, a client requests an object, e.g. Taj.gif. The object is accessed via a gateway 31 which incorporates the invention. The object may be cached 33 as a result of a prefetch operation, or it may be fetched upon execution of the request. When first requested, the object is routed to the compressor 13 and then it is both provided to the client and stored in its compressed form in the cache, e.g. as Taj.gif.vco. The object's header is maintained apart from the object in an uncompressed form, e.g. as Vco.html, to make it easy to locate the object without decompressing it. Various metadata can be included in the object name, such as format, resolution, and the like. FIG. 4 shows the invention in an embodiment where the object is fetched, compressed and stored in the cache and where multiple formats of the object exist, e.g. gif and PNG, and FIG. 5 shows a further case where the object is already in the cache and is merely retrieved in its compressed state.

Functionality

Below are the external functions that are used by the other modules.
* int http_a_prefetch(int wi, int flags);
* int http_vbuf_to_url (uchar *url, int bidx, int max_len);
* int vco_process_courl_request (int wi);
* int vco_process_http_request (int wi);
* int vco_set_compression_info (int wi);
* int fwd_vco_a_data(int wi, int idx, int ta_close, int flags);
* void vco_get_request_capability (int wi);

Requirements

The main interaction for VCO is between the HTTP requests, Prefetch Requests as well as the compressor.

Usability

The Graphical User Interface (GUI) on the server has the features that are configured. The Compression page is the main one on the GUI. It has the configuration for the Gif2Png, J2k. It also has the pop-up blocking and Lossy HTML filters as well. These are used by VCO to translate them into the compressor flags via the capability function.

GUI

| GIF to PNG Conversion | : [Image] |
|---|---|
| JPEG 2000 Support | : [Image] |
| Send Original Images on Reload | |
| Client/Server | : [Image] |
| ClientLess | : [Image] |

Below is the GUI for configuring the VCO feature:
Caching Compressed Object: [Image]

This is a checkbox which can be disabled or enabled.

Design Specification

Request Flow

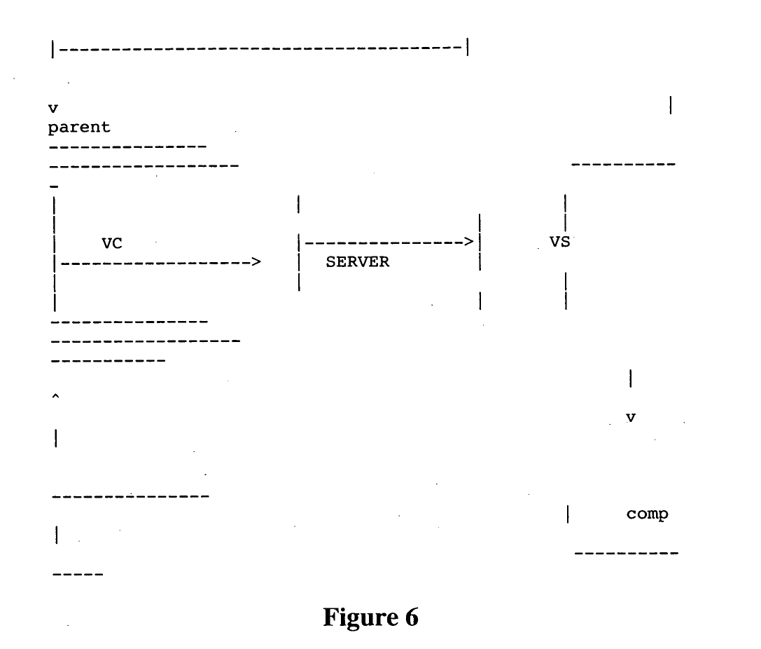

FIG. 6 is a flow diagram that describes the flow of the request. The request comes from the Client (VC). We need to check the VCO if the request is present or not. We differentiate between requests that come from Prefetch and from HTTP.

Request Comes From Prefetch

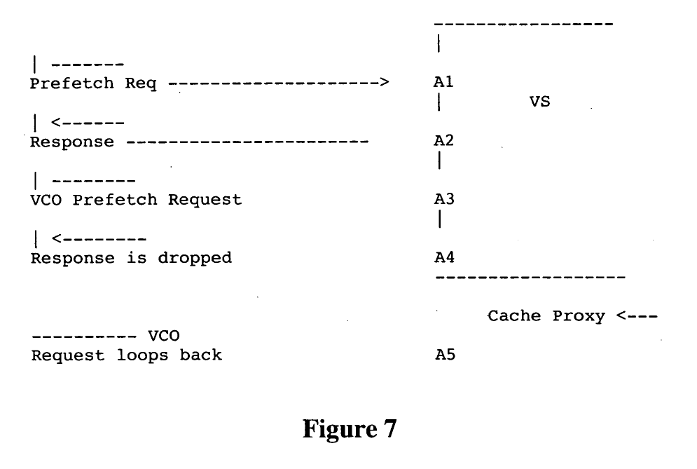

In this case the compressor parses the base html page and then issues requests for the objects embedded in the page. On the prefetch side, the flow is as shown in FIG. 7.

Prefetch

The Prefetch request is initiated by the VS. If the object does not exist in the VCO, we set up a request with a standard header. Then we send the request to the cache. The cache sees this as a normal request (A1) and fulfills the request either from the server or the Origin Server. When the response (A2) comes back, we send the data to the compressor with flags telling it to compress the data and not the response header. When the compressor sends back the compressed object, we save it in a temporary buffer. The compressor also tells us when the Original information and the compression information have been obtained. It then sets the aid (Application Identified) in a data structure. At that time the VS sends a COURL (A3) to the cache which is another request that is initiated by the VS. When the cache receives this request, it can fulfill it directly from the cache. When the response (A4) is obtained by VS, it drops the connection.

If the server does not have the data (first time for the request or it has been removed from disk), then it sends a request back to VS for the COURL on port 8009 of the cache proxy (A5). When VS obtains this request, it matches the request with the earlier request and then connects the two requests together. The socket from A3 is connected to A2 and A3 is closed. Then the data flows to A2 and then this response is dropped. Thus, the cache should have this data stored in it.

HTTP

The Request comes from HTTP. In this case, the request is being initiated by the browser through the VC or directly. In any case, we cannot drop the connection and hence the differentiation with the prefetch request. The flow in this case depends on whether the object is present in the VCO or not.

During this time, we save the Original information and the compression information in the various buckets that are relevant. The first we do not know what the compression information looks like.

If CO Is Not Present

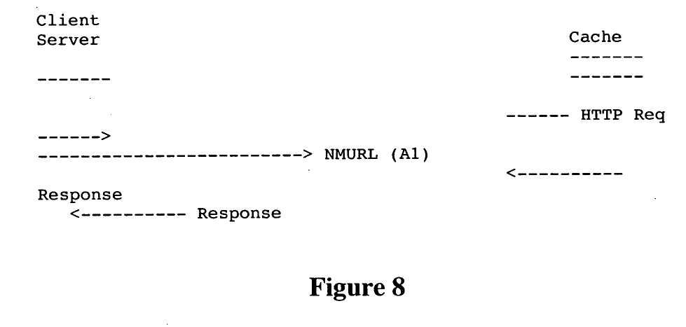

FIG. 8 is a flow diagram that describes the flow of the request when the CO is not present.

If CO Is Present

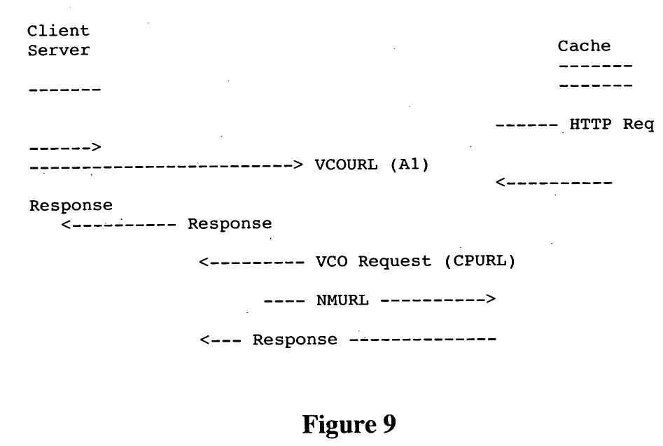

FIG. 9 is a flow diagram that describes the flow of the request when the CO is not present. In this case, we have a subsequent request for the same object.

Server Request

If the server has the compressed object, then it shall return it right away from the cache. This is where the actual benefit is of the VCO. We shall use the MCP for this purpose.

When the VCO request comes in through the MCP, based on the COURL, we know what entry is there in the VCO and also the extension gives us the Compression Information. This lets us co-relate the requests. We should set the hinfo based on these values and then issue a NMURL Request.

External Cache Support

The cache can work in the external mode as well. When the server is connected to an external cache, we send the HTTP request to the cache as a proxy request. The server then acts as an HTTP server and the external cache acts as an HTTP Client. The capability of the external cache to be able to send us the request back to server in case it ends with a VCO extension then determines if the External Cache can take advantage of this feature. The cache uses regular expressions that can issue the request back to us. Any other cache has to support this kind of configuration. The rest of the flow should happen similar to this and there are no special needs that we have to take care of.

Internal Structure

file formats

app.xml
<TABLE NAME=“HttpConfigurationTable” VERSION=“1.0”>

<COL name=“CompressedObjectEnabled” num=“12”

val=“0” />
</TABLE>
<TABLE NAME=“ApplicationMethodTable”
VERSTON=“0.0”>
<ROW>

<COL name=“Name” num=“1” val=“HTTPvco” />
<COL name=“ServerApplicationMethodName”

num=“2” val=“” />

<COL name=“ApplicationFunctionName” num=“3”

val=“HTTP” />

<COL name=“PacketMethodName” num=“4”

val=“EOF” />

<COL name=“timeout” num=“5” val=“0” />
<COL name=“ForwardChar” num=“6” val=“” />
<COL name=“MinCompBytecnt” num=“7”

val=“200” />

<COL name=“CompressionMethodName” num=“8”

val=“Http” />

<COL name=“ZLibDictName” num=“9”

val=“Default” />

<COL name=“Show” num=“10” val=“0” />

</ROW>

</TABLE>
<TABLE NAME=“ProxyMethodTable” VERSION=“0.0”>
<ROW>

<COL name=“MethodName” num=“1”

val=“Http_Vco” />

<COL name=“ProxyFunctionName” num=“2”

val=“HTTPvco” />

<COL name=“ApplicationMethodName” num=“3”

val=“HTTP” />

<COL name=“Port” num=“4” val=“800” />
<COL name=“UseDefaultDestination” num=“5”

val=“0” />

</ROW>

</TABLE>
<TABLE NAME=“MasterProxyTable” VERSION=“0.0”>
<ROW>

<COL name=“ProxyMethodName” num=“1”

val=“Http_Vco” />

<COL name=“StatsName” num=“2” val=“OTHER”

/>

<COL name=“Flags” num=“3” val=“1” />
<COL name=“ProxyHost” num=“4”

val=“127.0.0.1” / >

<COL name=“ProxyPort” num=“5” val=“8009” />
<COL name=“DestHost” num=“6” val=“” />
<COL name=“DestPort” num=“7” val=“0” />

</ROW>

</TABLE>

There are two other tables that have moved to the app.xml which has the configuration for the Gif2Png, PPM, J2k. Also the pop-up blocking and LossyHtml fields have been added. These are used by VCO to set the compressor flags based on the configuration.

<TABLE NAME=“SvrCompCfgTable” VERSION=“1.0”>

<ROW>

<COL name=“Gif2Png” num=“1” val=“1” />
<COL name=“PPM” num=“2” val=“1” />
<COL name=“J2k” num=“3” val=“1” />

</ROW>

</TABLE>
<TABLE NAME=“SvrCompLevelTable” VERSION=“1.0”>

<ROW>

<COL name=“Pop-upBlocking0” num=“1” val=“0”

/>

<COL name=“Pop-upBlocking1” num=“2” val=“0”

/>

<COL name=“Pop-upBlocking2” num=“3” val=“0”

/>

<COL name=“Pop-upBlocking3” num=“4” val=“0”

/>

<COL name=“Pop-upBlocking4” num=“5” val=“0”

/>

<COL name=“LossyHtml0” num=“6” val=“0” />
<COL name=“LossyHtml1” num=“7” val=“0” />
<COL name=“LossyHtml2” num=“8” val=“0” />
<COL name=“LossyHtml3” num=“9” val=“0” />
<COL name=“LossyHtml4” num=“10” val=“0” />

</ROW>

</TABLE>

The level 4 is internal and should always be off in the xml because it is used for the control-refresh mechanism.

data structures

#define MAX_VCO_COMP_INFO 42
// Original information
typedef struct {

| | | |
|---|---|---|
| ulong | type; | // what type of object it is |
| ulong | size; | // size in bytes of the actual object |
| ulong | pixels; | // size in pixels of the actual object |
| ulong | level; | // level for the original object - needs more |

detail
} VCO_ORIGINALINFO;
// Compressed information for each bucket
typedef struct {

| | | |
|---|---|---|
| ulong | entry_valid; | // is this entry valid |

| | | |
|---|---|---|
| ulong | comp_control_flags; | // control flags for completeness |

| | | |
|---|---|---|
| ulong | comp_flags; | // comp flags that need to passed |

to the
compressor

| | |
|---|---|
| ulong comp_level_dict; | // which level or dictionary to be |

used

| | | |
|---|---|---|
| ulong | comp_size; | // comp size |

| | | |
|---|---|---|
| ulong | final_size; | // final size of the object |

| | | |
|---|---|---|
| ulong | original_comp_flags; | // original flags |

| | | |
|---|---|---|
| int | wi; | // work item for saving VCO |

to
SQUID
} VCO_COMPRESSEDINFO;
typedef struct
{

| | | |
|---|---|---|
| int | id; | // index of the record |
| int | state; | // is it free or used |
| int | hash_index; | // hash bucket that it |

belongs to

| | | |
|---|---|---|
| int | hit_count; | // number of hits that this |

has got

| | | |
|---|---|---|
| int | pf_index_next; | // index of next record in |

hash
list

| | | |
|---|---|---|
| int | pf_index_prev; | // index of prev record in |

hash
list

| | | |
|---|---|---|
| int | pf_oldest_next; | // next oldest in the last |

acc.
order

| | | |
|---|---|---|
| int | pf_oldest_prev; | // prev oldest in the last |

acc.
order

| | | |
|---|---|---|
| int | state_flag; | // track the state of the |

record

| | | |
|---|---|---|
| VCO_ORIGINALINFO | original_info; | // original information of |

object

| | |
|---|---|
| VCO_COMPRESSEDINFO | comp_info[MAX_VCO_COMP_INFO]; // compression |

info

| | | |
|---|---|---|
| struct timeval | last_accessed_time; | // last accessed time |
| int | port; | // port of the request |
| char | host[HOST_SZ]; | // host of the request |
| uchar | url[PF_URL_SIZE+1]; | // URL object in the VCO |

} VCORcrdType;

There are currently six compressor types that are defined:

| | |
|---|---|
| #define COMP_TYPE_UNKNOWN | 0 |
| #define COMP_TYPE_NONE | 1 |
| #define COMP_TYPE_GIF | 2 |
| #define COMP_TYPE_JPG | 3 |
| #define COMP_TYPE_ZLIB | 4 |
| #define COMP_TYPE_HTML | 5 |

Unknown is when we do not know what type of object it is. Once the compressor has looked at the response, it can determine what the type is and it sets the type accordingly.

The compressor control flags are defined below. They represent the control to the compressor that the VentS sets before it sends the request out so that the compressor knows how to handle the response. Force is used for an object that we know the type for and we also know what flags should be set.

| | |
|---|---|
| #define VCO_CC_FORCE | 0x00000001 |
| #define VCO_CC_COMP_HDR | 0x00000002 |
| #define VCO_CC_COMP_BODY | 0x00000004 |
| #define VCO_CC_ZLIB_HDR | 0x00000008 |
| #define VCO_CC_VALID | 0x00000010 |
| #define VCO_CC_PREFETCH | 0x00000100 |
| #define VCO_CC_HEAD | 0x00000200 |

The compressor hdr and compressor body flags are used for letting the compressor know what section of the response needs to be compressed. ZLIB header is also set accordingly. The VALID flag is used as a signal from the compressor to the VentS as a way to let it know that the values coming back are valid. PREFETCH is set to indicate that the prefetch feature has been turned on and that objects within a HTML can be prefetched. HEAD is indicative of the head request, so that we do not have a body to it.

Below are the compressor flags that are sent from the VentS to the compressor and back again. When the VentS sets the values, it looks at the capability of the request and determines which of these flags need to be set. When the compressor sets the VALID flag, it also indicates what it did to the object so we can act appropriately.

| | |
|---|---|
| #define VCO_CF_STDDICT | 0x00000001 |
| #define VCO_CF_LDDICT | 0x00000002 |
| #define VCO_CF_PPM | 0x00000004 |
| #define VCO_CF_DEFLATE | 0x00000008 |
| #define VCO_CF_GZIP | 0x00000010 |
| #define VCO_CF_GIF2PNG | 0x00000020 |
| #define VCO_CF_POP-UP_BLOCK | 0x00000040 |
| #define VCO_CF_LOSSY_HTML | 0x00000080 |
| #define VCO_CF_CHUNK | 0x00000100 |
| #define VCO_CF_J2K | 0x00000200 |

These flags are set from the compressor. These shall be used by the VCO to send them back:

| | |
|---|---|
| #define VCO_CF_ANIMATE | 0x00001000 |
| #define VCO_CF_LOSSLESS | 0x00002000 |
| #define VCO_CF_LOSSY | 0x00004000 |

For the Gif images, we have a choice of gif, gif2png with chunking for each level. Because there are five levels to consider there are the following combinations potentially allowed:

| | |
|---|---|
| #define VCO_ST_GIF_NONE | 0 |
| #define VCO_ST_GIF_L0 | 1 |
| #define VCO_ST_GIF_L1 | 2 |
| #define VCO_ST_GIF_L2 | 3 |
| #define VCO_ST_GIF_L3 | 4 |
| #define VCO_ST_GIF_L4 | 5 |
| #define VCO_ST_GIF_CHUNK_L0 | 6 |
| #define VCO_ST_GIF_CHUNK_L1 | 7 |
| #define VCO_ST_GIF_CHUNK_L2 | 8 |
| #define VCO_ST_GIF_CHUNK_L3 | 9 |
| #define VCO_ST_GIF_CHUNK_L4 | 10 |
| #define VCO_ST_GIF_PNG_L0 | 11 |
| #define VCO_ST_GIF_PNG_L1 | 12 |
| #define VCO_ST_GIF_PNG_L2 | 13 |
| #define VCO_ST_GIF_PNG_L3 | 14 |
| #define VCO_ST_GIF_PNG_L4 | 15 |
| #define VCO_ST_GIF_PNG_CHUNK_L0 | 16 |
| #define VCO_ST_GIF_PNG_CHUNK_L1 | 17 |
| #define VCO_ST_GIF_PNG_CHUNK_L2 | 18 |
| #define VCO_ST_GIF_PNG_CHUNK_L3 | 19 |
| #define VCO_ST_GIF_PNG_CHUNK_L4 | 20 |
| #define VCO_ST_GIF_MAX_BUCKET | |
| VCO_ST_GIF_PNG_CHUNK_L4 + 1 | |

For the JPEG images, we have a choice of jpeg, j2k, chunking for each level:

| | |
|---|---|
| #define VCO_ST_JPG_NONE | 0 |
| #define VCO_ST_JPG_L0 | 1 |
| #define VCO_ST_JPG_L1 | 2 |
| #define VCO_ST_JPG_L2 | 3 |
| #define VCO_ST_JPG_L3 | 4 |
| #define VCO_ST_JPG_L4 | 5 |
| #define VCO_ST_JPG_CHUNK_L0 | 6 |
| #define VCO_ST_JPG_CHUNK_L1 | 7 |
| #define VCO_ST_JPG_CHUNK_L2 | 8 |
| #define VCO_ST_JPG_CHUNK_L3 | 9 |
| #define VCO_ST_JPG_CHUNK_L4 | 10 |
| #define VCO_ST_JPG_J2K_L0 | 11 |
| #define VCO_ST_JPG_J2K_L1 | 12 |
| #define VCO_ST_JPG_J2K_L2 | 13 |
| #define VCO_ST_JPG_J2K_L3 | 14 |
| #define VCO_ST_JPG_J2K_L4 | 15 |
| #define VCO_ST_JPG_J2K_CHUNK_L0 | 16 |
| #define VCO_ST_JPG_J2K_CHUNK_L1 | 17 |
| #define VCO_ST_JPG_J2K_CHUNK_L2 | 18 |
| #define VCO_ST_JPG_J2K_CHUNK_L3 | 19 |
| #define VCO_ST_JPG_J2K_CHUNK_L4 | 20 |
| #define VCO_ST_JPG_MAX_BUCKET | |
| VCO_ST_JPG_J2K_CHUNK_L4 + 1 | |

For the type of ZLIB, we use the following subtypes. The subtypes are for five different types:
PPM
zlib with standard dictionary
zlib with loadable dictionary
DEFLATE
GZIP

Then you have a choice of chunking or not. This leads to the following combinations.

| | |
|---|---|
| #define VCO_ST_ZLIB_NONE | 0 |
| #define VCO_ST_PPM | 1 |
| #define VCO_ST_STD_DICT | 2 |
| #define VCO_ST_LD_DICT | 3 |
| #define VCO_ST_DEFLATE | 4 |
| #define VCO_ST_GZIP | 5 |
| #define VCO_ST_PPM_CHUNK | 6 |
| #define VCO_ST_STD_DICT_CHUNK | 7 |
| #define VCO_ST_LD_DICT_CHUNK | 8 |
| #define VCO_ST_DEFLATE_CHUNK | 9 |
| #define VCO_ST_GZIP_CHUNK | 10 |

For the type of HTML:

This is treated as a special kind of type compared to the other ZLIb options. It has the maximum number of options.

There are the following subtypes: STD Dictionary, Loadable Dictionary, PPM, Deflate and GZIP.

For each subtype there is a choice of chunking, lossy HTML and pop-up Blocking. Thu, there are 5*8=20 combinations of buckets that are manipulated. This leads to the following combinations of the buckets.

| | |
|---|---|
| #define VCO_ST_HTML_NONE | 0 |
| #define VCO_ST_STD_DICT_NLHNPB | 1 |
| #define VCO_ST_STD_DICT_NLHPB | 2 |
| #define VCO_ST_STD_DICT_LHNPB | 3 |
| #define VCO_ST_STD_DICT_LHPB | 4 |
| #define VCO_ST_STD_DICT_CHUNK_NLHNPB | 5 |
| #define VCO_ST_STD_DICT_CHUNK_NLHPB | 6 |
| #define VCO_ST_STD_DICT_CHUNK_LHNPB | 7 |
| #define VCO_ST_STD_DICT_CHUNK_LHPB | 8 |
| #define VCO_ST_LD_DICT_NLHNPB | 9 |
| #define VCO_ST_LD_DICT_NLHPB | 10 |
| #define VCO_ST_LD_DICT_LHNPB | 11 |
| #define VCO_ST_LD_DICT_LHPB | 12 |
| #define VCO_ST_LD_DICT_CHUNK_NLHNPB | 13 |
| #define VCO_ST_LD_DICT_CHUNK_NLHPB | 14 |
| #define VCO_ST_LD_DICT_CHUNK_LHNPB | 15 |
| #define VCO_ST_LD_DICT_CHUNK_LHPB | 16 |
| #define VCO_ST_PPM_NLHNPB | 17 |
| #define VCO_ST_PPM_NLHPB | 18 |
| #define VCO_ST_PPM_LHNPB | 19 |
| #define VCO_ST_PPM_LHPB | 20 |
| #define VCO_ST_PPM_CHUNK_NLHNPB | 21 |
| #define VCO_ST_PPM_CHUNK_NLHPB | 22 |
| #define VCO_ST_PPM_CHUNK_LHNPB | 23 |
| #define VCO_ST_PPM_CHUNK_LHPB | 24 |
| #define VCO_ST_DEF_NLHNPB | 25 |
| #define VCO_ST_DEF_NLHPB | 26 |
| #define VCO_ST_DEF_LHNPB | 27 |
| #define VCO_ST_DEF_LHPB | 28 |
| #define VCO_ST_DEF_CHUNK_NLHNPB | 29 |
| #define VCO_ST_DEF_CHUNK_NLHPB | 30 |
| #define VCO_ST_DEF_CHUNK_LHNPB | 31 |
| #define VCO_ST_DEF_CHUNK_LHPB | 32 |
| #define VCO_ST_GZIP_NLHNPB | 33 |
| #define VCO_ST_GZIP_NLHPB | 34 |
| #define VCO_ST_GZIP_LHNPB | 35 |
| #define VCO_ST_GZIP_LHPB | 36 |
| #define VCO_ST_GZIP_CHUNK_NLHNPB | 37 |
| #define VCO_ST_GZIP_CHUNK_NLHPB | 38 |
| #define VCO_ST_GZIP_CHUNK_LHNPB | 39 |
| #define VCO_ST_GZIP_CHUNK_LHPB | 40 |
| #define VCO_ST_GZIP_MAX_BUCKET | |
| VCO_ST_GZIP_CHUNK_LHPB + 1 | |

Below is the hinfo structure that is used to pass information from the VentS to/from the Compressor.

typedef struct
{

| | |
|---|---|
| ulong type; | /* type of the object |
| */ | |

| ulong | original_size; | |
|---|---|---|
| ulong | original_pixels; | |
| ulong | original_level; | |
| ulong | comp_control_flags; | |
| ulong | comp_flags; | /* compressor/APP flags |

| */ | | |
|---|---|---|
| ulong | compressed_size; | |
| ulong | comp_level_dict; | |
| ulong | final_size; | |
| ulong | original_comp_flags; | /* Save these for later */ |

| | |
|---|---|
| } | HdCompInfo; |

| | |
|---|---|
| typedef | struct |

{

| | | |
|---|---|---|
| int | port; | /* saves port from header |

*/

| | | |
|---|---|---|
| int | port1; | /* holds port from transparent |

proxy */

| | | |
|---|---|---|
| int | flags; | /* HS_{—} values |

*/

| | | |
|---|---|---|
| int | encoding; | /* HCE_{—} values |

*/

| | | |
|---|---|---|
| int | hlength; | /* header length |

*/

| | | |
|---|---|---|
| int | clength; | /* Content-Length |

*/

| | | |
|---|---|---|
| int | slength; | /* active scratch buffer size |

*/

| | | |
|---|---|---|
| int | state; | /* lexer state |

*/

| int | ins; | |
|---|---|---|
| int | end; | /* byte count to the end of |

| | |
|---|---|
| current | file */ |

| | |
|---|---|
| struct in_addr src_addr; | /* address of client or user |

agent */

| | |
|---|---|
| DRcrd data; | /* modified data stream |

*/

| | |
|---|---|
| DRcrd out; | /* request header extracted from |

data steam */

| | |
|---|---|
| DRcrd url; | /* base url extracted from data |

steam */

| | |
|---|---|
| HdCompInfo compInfo; | /* compression information |

*/

| | |
|---|---|
| uchar host[HOST_SZ]; | /* host name string from |

authority */

| | |
|---|---|
| uchar host1[HOST_SZ]; | /* host name string from Host: |

field */

| | |
|---|---|
| uchar userinfo[HOST_SZ]; | /* user information string |

*/

| | |
|---|---|
| uchar add[HOST_SZ]; | /* data to add at the end of the |

header */

| | |
|---|---|
| uchar schema[SCHEMA_LEN]; | /* schema for the request |

*/

| | |
|---|---|
| uchar vco_url_extension[32]; | /* |

VCO_COURL_EXTENSION_LEN

*/

| | |
|---|---|
| uchar scratch[SCRATCHSZ]; | /* scratch memory area |

*/

| | |
|---|---|
| } | HdInfo; |

Function Description

This section describes in some detail the code that has been implemented in the presently preferred embodiment of the invention.

Internal Functions to VCO
* static int vco_get_courl_extension (int wi, uchar *co_extension)

The co url extension has the following format: .vco_<type %Iu>_<comp_flags %Ix>_<Iddict %Iu>_vco

The server has been configured to support the _vco at the very end. It sends such requests to the Cache Proxy (back to VentS).

The request in the access logs of the server is something similar to:

1067672272.136 22 127.0.0.1 TCP_MISS/200 541 GET
http://www.employees.org/˜pradeep/vco.html.vco_5_8_0_vco -
DEFAULT_PARENT/127.0.0.1 text/html
1067673025.244 2 127.0.0.1 TCP_MEM_HIT/200 3452 GET
http://www.employees.org/˜pradeep/images/feedback.gif.vco_2
_5020_2_vco -
NONE/- image/gif

* static int vco_get_ci_from_courl_extension
(uchar *co_extension, ulong *type, ulong *comp_flags, ulong *Id_dict)

This function takes input the CO extension and returns back the type, comp_flags and Id_dict.
* static void vco_update_prefetch_record (int wi)

This is used to update the prefetch record when the prefetch request or the VCO Prefetch request has been completed.
* static int get_compression_index (int wi, int *cidx)

This gets the bucket that we need to see what the compression values are present.
* static int vco_set_hinfo_by_record (int wi, int cidx)

This function gets the information from the particular bucket in the VCO Table and sets the hinfo based on that. This is used for subsequent requests for which we have the flags available to be used from a prior completion.
* static void vco_set_other_buckets (int wi, int cidx)

This function is called when we decide to set the other buckets that have the same characteristics.

The following is a brief description of the buckets. Lets take an example of the ZLIB type of object.

| | PPM | LDDICT | STDDICT | None | Deflate | GZIP |
|---|---|---|---|---|---|---|
| PPM | x | x | x | x | | |
| LDDICT | | x | x | x | | |
| STDDICT | | | x | x | | |
| DEFLATE | | | | x | x | |
| GZIP | | | | x | | x |

The left hand column is what we send to the compressor as flags that we support. The other columns are the values that the compressor sets when it wants to set the compression information. Then there is the combination of chunking or not.

Let us say that we sent the compression flags as below to the compressor for some object:

```
comp info: original_type = 0 0 0 0xc 0x7138 0 3 0 0x7138
compressor flags  VCO_CF_DEFLATE VCO_CF_GZIP
    VCO_CF_GIF2PNG VCO_CF_CHUNK VCO_CF_ANIMATE
    VCO_CF_LOSSLESS  VCO_CF_LOSSY
compressor control flags VCO_CC_COMP_BODY
VCO_CC_ZLIB_HDR
```

When the compressor comes back with the valid flags,

comp info: original_type = 5 0 0 0 0x1c 0x8 0 0 0 0x7138
compressor flags VCO_CF_DEFLATE
compressor control flags VCO_CC_COMP_BODY
VCO_CC_ZLIB_HDR
VCO_CC_VALID

Now that we know the type is 5 (HTML), we can determine that the request has a bucket of 29. VCO_ST_DEF_CHUNK_NLHNPB. This means that it is a deflate as well as chunked supported and no lossy html and no pop-up blocking.

Now the question is if there are any other buckets that can be filled with this information so we can VCO those as well. It turns out that VCO_ST_DEF_NLHNPB is another bucket (25) that can be used. This has the similar characteristics that it is deflate, it has no lossy html and no pop-up blocking set. The only difference is that chunking is not set. But the compressor when it compressed the object did not set the chunking bit. We can use this bucket as well. This way if we get a HTTP/1.0 request (no chunking), then we can still service the request. There could be multiple combinations in some cases as well. This way VCO can get maximum gain from the product. This same exercise could be done for other types of objects.
* static void vco_copy_cidx_new (int wi, int cidx, int cidx_new)

This is a utility function that copies the bucket information from the old index (cidx) to the new index (cidx_new). This is used by the vco_set_other_buckets to set the parameters for the other bucket(s) as well.
* static void print_compression_info (HdCompInfo *comp_info)

This is one of the utility debug functions that prints the content of the compression Information in a easier to read manner. It is controlled via a #define VCO_PRINT 9// change to 100 to be off.

External Functions
* int vco_process_http_request (int wi)

This function is called for an HTTP request that has come in from a clientless or client user. Once the connection has been established and we need to set the request out, we call this function. The purpose of this function is to determine how we are going to process the request. We need to set the compressor flags regardless of VCO or Prefetch or not.

Output:
−1: there is an error and request cannot be processed
0: OK
1: the parser needs to be called again to add the extension

It sets the values in the hinfo structure. It also determines if this is the first time it is going through the Prefetch Record Table (VCO Table) and then if we need to convert this into the VCO URL request or not.
* int vco_process_courl_request (int wi)

This function is called when we want to process the Cache Proxy Request coming in through the cache proxy port from the server. It parses the extension and gets the compression information that it needs to use. For this request, because it is going to go to the server, only the body should be compressed. In case of prefetch, there is a possibility that we get the wiOld data from the previous connection that caused the server to send us the request. In this case we just connect the two requests and then we are done. If the old request is not lying around, then we convert this request into the original URL and send it out.
* int vco_set_compression_info (int wi)

This function is called when the compressor has the compression information. It sets the values in the hinfo structure and sets the VALID flag in the cache control flags. This is an indication to the VentS that the information has been made available. The purpose of this function is to set the compression information in the bucket for the request. If the original information is not set then it sets the original type, size, and level. It then gets the bucket that it is interested in and sets the values for the comp_flags, comp_control_flags and other parameters. Then it goes ahead and sets the other buckets which could have the same characteristics.
* void vco_get_request_capability (int wi)

This function is used to get the capabilities of the request. This is obtained via three ways:
1. Server Configuration: The server decides some of the flags that are set.
2. Client Capability.
3. Request Capability.

The compressor flags are set based on the above. The first time we do not know what kind of request it is, so we set the fields for the compinfo to unknown. Then we need to set the compressor flags. The following is a brief description for each of the flags:

| Compressor Flag | Description |
|---|---|
| VCO_CF_STDDICT | This compressor flag denotes that the |
| | client is capable of handling standard |
| | dictionaries. |
| | This is set based on the AG_ZLIB in the |
| | rcp->status. |
| VCO_CF_LDDICT | This compressor flag denotes that the |
| | client is capable of handling loadable |
| | dictionaries. |
| | This is set based on the AG_LDDICT in |
| | the rcp->status. This comes from the client |
| | capabilities. |
| VCO_CF_PPM | This compressor flag is set when the |
| | client is capable of PPM compression method. |
| | It is based on AG_PPM in the rcp->status as |
| | well as the server SvrCompCfg.ppmd. This |
| | configuration parameter is in the app.xml on |
| | server and is always ON. |
| VCO_CF_DEFLATE | This flag is set when we are in |
| | clientless mode and the encoding is HCE_DEFLATE |
| | and HttpCfg.ss_comp == 1 OR HttpCfg.ss_comp == 3. |
| | This flag is reset if we are dealing with a older |
| | version of Netscape. |
| VCO_CF_GZIP | This flag is set when we are in |
| | clientless mode and the encoding is HCE_GZIP and |
| | HttpCfg.ss_comp == 1 OR HttpCfg.ss_comp == 2. |
| | This flag is reset if we are dealing with a older |
| | version of Netscape. |
| VCO_CF_GIF2PNG | This flag is set when |
| | Gif2PNG (SvrCompCfg.gif2png) is enabled |
| | and the browser supports gif2png conversion |
| | (it is not a HS_BADIE or VCO_CF_GIF2PNG. |
| VCO_CF_POP-UP_BLOCK | This flag is set when the pop-up |
| | blocking has been enabled on the compression page. |
| VCO_CF_LOSSY_HTML | This flag is set when the lossy html |
| | has been enabled on the compression page. |
| VCO_CF_CHUNK | This flag is set when the browser is |
| | capable of understanding chunk data. This really |
| | means the request is HS_HTTP1_1. |
| VCO_CF_J2K | This flag is set when the server has |
| | been enabled by J2K and the client capability say |
| | that it is supporting J2K. |
| VCO_CF_ANIMATE | This flag is always set the first time. |
| | It just lets the compressor know that animated |
| | images are supported. |
| VCO_CF_LOSSLESS | This flag is always set the first time. |
| VCO_CF_LOSSY | This flag is always set the first time. |

*int vco_get_comp_control_flags (int wi, int flags)

The compressor control flags are set based on certain parameters. The parameters are:
1. Clientless: This lets us know if the request is from a clientless user or from a client.
2. VCO: This lets us know if the cached object has been found in the VCO table or not.
3. Prefetch: This lets us know if the request is a prefetch request or not.
4. CacheProxy: This is the request that comes back from the server to us on port 8009 and is the VCO request.

Based on these parameters, we decide if we want to use the FORCE, COMP_HDR or COMP_BODY flags. “No” means that it is not set. “Yes” means that it is set. “-” means that this is not possible. The flag is meant to set the VCO parameter. Others are found by the configuration parameters.

| | | | Cache | | | |
|---|---|---|---|---|---|---|
| Clientless | VCO | Prefetch | Proxy | VCO_CC_FORCE | VCO_CC_COMP_HDR | VCO_CC_COMP_BODY |
| 0 | 0 | 0 | 0 | No | Yes | Yes |
| 0 | 0 | 0 | 1 | — | — | — |
| 0 | 0 | 1 | 0 | No | No | Yes |
| 0 | 0 | 1 | 1 | — | — | — |
| 0 | 1 | 0 | 0 | Yes | Yes | No |
| 0 | 1 | 0 | 1 | Yes | No | Yes |
| 0 | 1 | 1 | 0 | No | No | No |
| 0 | 1 | 1 | 1 | Yes | No | Yes |
| 1 | 0 | 0 | 0 | No | No | Yes |
| 1 | 0 | 0 | 1 | — | — | — |
| 1 | 0 | 1 | 0 | No | No | Yes |
| 1 | 0 | 1 | 1 | — | — | — |
| 1 | 1 | 0 | 0 | Yes | No | No |
| 1 | 1 | 0 | 1 | Yes | No | Yes |
| 1 | 1 | 1 | 0 | No | No | No |
| 1 | 1 | 1 | 1 | Yes | No | Yes |

This also sets the VCO_CC_HEAD if the request is a head request. It also sets the VCO_CC_PREFETCH flag if the request is a prefetch request.
* int vco_http_process_courl_prefetch (int wi)

The purpose of this function is to process the courl that needs to be prefetched. Once we have the original Prefetch request sent out and the response comes back, we save the compressed body and original header. Then we issue this call for the COURL. If the cache has this object we are done. Otherwise it loops around and then sends a CPU RL (port 8009) to VentS. Then the CPURL is processed and the two requests are tied together. This way the cache can get the CPURL in a proper way.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for storing and accessing objects, comprising:
a client for requesting an object;
a server for retrieving said requested object;
a compressor for compressing said requested object a first time said object is requested; and
a gateway for providing said compressed object to said client in response to said request, and for storing said compressed object in a cache for reuse.

2. The apparatus of claim 1, said compressor further comprising:
means for effecting any of a plurality of levels of compression;
wherein said gateway stores a copy of said object at each level of compression that is applied to said object.

3. The apparatus of claim 1, further comprising:
a translation facility for converting said object from its native format to any of a plurality of target formats;
wherein said gateway stores a copy of said object in each target format to which said object is translated.

4. The apparatus of claim 1, further comprising:
means for prefetching said object;
wherein said object is compressed and stored in said cache prior to a request therefor.

5. The apparatus of claim 1, said object further comprising:
a header.

6. The apparatus of claim 5, wherein said header is compressed.

7. The apparatus of claim 5, wherein said header is uncompressed.

8. The apparatus of claim 1, further comprising:
a table for identifying and locating a cached, compressed object when said object is requested.

9. The apparatus of claim 1, said object further comprising:
metadata associated with said object.

10. The apparatus of claim 9, said metadata comprising any of:
object identification information, object compression factor; object resolution;
object format; object scaling factor; and object encryption information.

11. A method for storing and accessing objects, comprising the steps of:
a client requesting an object;
a server retrieving said requested object;
compressing said requested object a first time said object is requested;
providing said compressed object to said client in response to said request; and
storing said compressed object in a cache for reuse.

12. The method of claim 11, said compressing step further comprising the step of:
effecting any of a plurality of levels of compression;
wherein a copy of said object is stored at each level of compression that is applied to said object.

13. The method of claim 11, further comprising the step of:
converting said object from its native format to any of a plurality of target formats;
wherein a copy of said object is stored in each target format to which said object is translated.

14. The method of claim 11, further comprising the step of:
prefetching said object;
wherein said object is compressed and stored in said cache prior to a request therefor.

15. The method of claim 11, said object further comprising:
a header.

16. The method of claim 15, wherein said header is compressed.

17. The method of claim 15, wherein said header is uncompressed.

18. The method of claim 11, further comprising the step of:
providing a table for identifying and locating a cached, compressed object when said object is requested.

19. The method of claim 11, said object further comprising:
metadata associated with said object.

20. The method of claim 19, said metadata comprising any of:
object identification information, object compression factor; object resolution; object format; object scaling factor; and object encryption information.

21. A method for storing and accessing objects, comprising the steps of:
compressing an object once;
saving said compressed object to a cache for reuse;
retrieving said compressed object from said cache directly; and
sending said compressed object directly to a client.

22. The method of claim 21, further comprising the step of:
saving an original, uncompressed object in said cache.

23. The method of claim 22, wherein once said original uncompressed object is received, data in said object are compressed, but an object header is not compressed.

24. The method of claim 21, further comprising the step of:
said compression step saving information internally to identify a compression technique used.

25. The method of claim 21, wherein when a request for an object is made again, an identifier for said object is translated into a corresponding compressed object identifier, which is maintained in an internal table.

26. The method of claim 21, further comprising the step of:
maintaining said object as a compressed data portion and a separate, uncompressed header portion;
wherein said header is used to identify said object;
wherein when a compressed object is requested, said object header can be compressed quickly because it is much smaller in size than the data which comprise said object itself.

27. A method for storing and accessing objects, comprising the steps of:
initiating a prefetch request for an object;
if said object does not exist in a cache as a compressed object, setting up a request with a standard header;
sending said request to a server, said server fulfilling said request either from said server or from an origin server;
when a response comes back from said server, sending said object to a compressor with flags telling it to compress data associated with said object but not a response header;
when said compressor sends back a compressed object, saving said compressed object in a queue;
sending a second request to said server;
when said server receives said second request, said server fulfilling said second request directly from said cache.
